(19) United States
(12) Patent Application Publication
(10) Pub. No.: US 2002/0101074 A1
(43) Pub. Date: Aug. 1, 2002

(54) Tri-fold label with separable packing list and adhesive backing enclosure

(75) Inventor: Michael J. Marchetti, Glenellyn, IL (US)

Correspondence Address: KAUFMAN & CANOLES, ATTN: PETER A. SHADDOCK II, ONE COMMERCIAL PLACE, P.O. BOX 3037, NORFOLK, VA, 23514, US

(73) Assignee: SFI of Delaware, LLC

(21) Appl. No.: 09/771,759

(22) Filed: Jan. 29, 2001

(51) Int. Cl. B42D 15/00

(52) U.S. Cl. 283/81

(57) ABSTRACT

A tri-fold label with a separable packing list and adhesive backing enclosure including a single label that is formed into a shipping label, a packing list, and a packing list enclosure. The back of the shipping label and the packing list enclosure are coated with a pressure sensitive adhesive layer. Thus, the shipping label may be removed from a backing sheet and applied to any desired supporting surface, such as, for example, an exterior surface of a container. The packing list portion of the tri-fold label can be Z-folded in such a manner as to form a multi-layer laminate with the packing list enclosure completely covering and enclosing the folded packing list. Thus, the packing list enclosure (including the packing list) can be separately applied to, for example, another portion of the exterior surface of the container.

### BACKGROUND OF THE INVENTION

1. Field of the Invention

This invention relates to shipping labels and packing lists.

2. Description of Related Art

Generally, when goods are shipped to a customer through, for example, a private courier or the United States Postal Service, the container or package used to hold the goods usually includes both a shipping label and a packing list. The shipping label is typically applied to an outside surface of the container and identifies the address where the container is to be delivered. Furthermore, the shipping label is usually applied in a conspicuous location so that the delivery address can be readily ascertained.

The packing list is typically a separate document that supplies detailed information about the goods that are being shipped in the container. If the packing list is included inside the container, the container must be opened if the contents of the container are to be known. Thus, in certain instances, it is preferable to at least affix a copy of the packing list to the exterior of the container. In this manner, one can ascertain the contents of a given container without opening the container.

Various methods and apparatuses for attaching a packaging list to the exterior of a container are known. For example, the packing list can be carried in a see-through pouch that is attached, by a self-adhesive layer, to an exterior surface of the container prior to shipment.

A similar method for attaching a packaging list to the exterior of a container includes the use of a transparent-front, adhesive-backed, packing slip container, wherein the packing slip container has a clear front panel attached at its periphery to a front of a backing panel of paper, plastic, or light cardboard. A second side of the backing panel includes an adhesive that is covered with a releasable protective covering. A slit formed through the backing panel, adhesive, and releasable protective covering allows a folded combination shipping label/packing list document, such as, for example a packing slip or an invoice, to be inserted into a hollow space created between the front panel and the backing panel.

Both the shipping address for the container and the packing list information can be entered in pre-established locations of the packing slip such that, when the completed packing slip is folded in a pre-established manner and placed within the hollow space between the front panel and the backing panel, the address will be visible through the front panel.

### SUMMARY OF THE INVENTION

Unfortunately, known methods and apparatuses for affixing a packing list to a shipping container fail to provide a simple and convenient method for including shipping address and packing information in a single, separable document that is easily affixed to a shipping container. Furthermore, known methods and apparatuses require a number of steps to affix shipping labels and packing lists to shipping containers.

Thus, the present invention provides a unitary combined shipping and packing list label that can be printed completely by computer-driven machinery and affixed to a container in a manner sufficient to prevent the label from being inadvertently torn from the container. Specifically, this invention provides a tri-fold label with a separable packing list and adhesive backing enclosure.

In various exemplary embodiments of the tri-fold label with separable packing list and adhesive backing enclosure according to this invention, a single label is formed into a shipping label, a packing list, and a packing list enclosure. The back of the shipping label and the packing list enclosure are coated with a pressure sensitive adhesive layer. Thus, the shipping label may be removed from a backing sheet and applied to any desired supporting surface, such as, for example, an exterior surface of a container. The packing list portion of the tri-fold label can be Z-folded in such a manner as to form a multi-layer laminate with the packing list enclosure completely covering and enclosing the folded packing list. Thus, the packing list enclosure (including the packing list) can be separately applied to, for example, another portion of the exterior surface of the container.

In one exemplary embodiment of the tri-fold label with separable packing list and adhesive backing enclosure according to this invention, the tri-fold label comprises a first layer, or face stock, and a second layer, or backing, each having a first side and a second side. The first side of the face stock has an exposed, printable, generally planar surface. The printable surface is divided into a first printable area and a second printable area separated from one another by a common edge along one side thereof.

The first side also includes a border area substantially surrounding all four sides of the first printable area, giving the first side of the face stock an overall T-shaped configuration. In various exemplary embodiments, the first printable area is suitable for imprinting a shipping address and the second printable area suitable for imprinting packing information.

At least a portion of the second side of the face stock is coated with a pressure sensitive adhesive layer. Preferably, the entire second side of the face stock in the border area is coated with a pressure sensitive adhesive layer that allows the tri-fold label to be adhesively applied to any desired supporting surface, such as, for example, an exterior surface of a container.

In various exemplary embodiments, the adhesive may be a removable, repositionable, or permanent adhesive that can be hot-melt, emulsion, or solvent-based. It should be understood that varying types of adhesives may be used in each of the first printable area, the border area, or the second printable area. Depending on the desired application, the particular adhesive that is used in each of the first printable area, the border area, and the second printable area is a design choice and will be obvious and predicable to those skilled in the art.

For example, the entire second side of the face stock in the first printable area and the border area may be coated with a pressure sensitive adhesive layer, while the entire second side of the face stock in the second printable area may be coated with a permanent adhesive layer. In this manner, the backing may be removed from the second side of the face stock in the first printable area and the border area, while the backing is permanently adhered to the second side of the face stock in the second printable area.

In various exemplary embodiments, the backing is, for example, a carrier strip having a non-stick release coating, such as a silicon layer, applied to the first side thereof. The backing contacts and covers the adhesive layer coated on the second side of the face stock. It should be understood that if, for example, a pressure sensitive adhesive is used in any area of the second side of the face stock, the backing removably covers that area. Likewise, if, for example, a permanent adhesive is used in any area of the second side of the face stock, the backing permanently covers that area.

An outer, generally U-shaped portion of the backing that protectively covers the border area of the face stock is separable from the backing. The outer section of the backing must be removed from the tri-fold label in preparation for adhering the tri-fold label to an exterior surface of a container. After removal, this outer section of the backing defines a waste portion of the backing.

The tri-fold label according to this invention can be pre-printed with any desired indicia common to shipping labels, such as the shipper's return address or instructions for using or removing the tri-fold label. The various sections of the tri-fold label can be formed with predetermined perforations or serrations. The perforations can be die cut through the various layers of the tri-fold label from blank continuous label stock or web. The blank continuous label stock typically includes four parts: namely, the face stock; an adhesive layer; a silicon layer; and a carrier or backing.

Accordingly, this invention provides a tri-fold label with a separable shipping label and packing list.

This invention separately provides a tri-fold label with an improved enclosure for attaching a packing list to a container.

This invention separately provides a tri-fold label with a separable first printable area suitable for imprinting a shipping address and a second printable area suitable for imprinting packing information.

These and other features and advantages of this invention are described in or are apparent from the following detailed description of the exemplary embodiments, the accompanying drawings, and/or the appended claims.

### BRIEF DESCRIPTION OF THE DRAWINGS

The exemplary embodiments of this invention will be described in detail, with reference to the following figures, wherein like reference numerals refer to like parts throughout the several views, and wherein:

FIG. 1 is a plan view of the first side of one embodiment of a tri-fold label with separable packing list and adhesive backing enclosure according to this invention;

FIG. 2 is a plan view of the second side of the embodiment of the tri-fold label with separable packing list and adhesive backing enclosure according to this invention, as shown in FIG. 1;

FIG. 3 is a plan view of the second side of the outer backing removed from the tri-fold label according to this invention, as shown in FIGS. 1 and 2;

FIG. 4A is a plan view of the first side of the tri-fold label according to this invention with the outer backing removed for application to an exterior surface of a shipping container;

FIG. 4B is a plan view of the second side of the tri-fold label of FIG. 4A;

FIG. 4C is a plan view of the second side of the tri-fold label of FIGS. 4A and 4B folded along first and second fold lines;

FIG. 5A is a perspective view of the tri-fold label according to this invention with the outer backing removed and folded along first and second perforated fold lines;

FIG. 5B is a perspective view illustrating a first step in the application of the tri-fold label assembly shown in FIG. 5A to a shipping container;

FIG. 6A is a perspective view of the tri-fold label according to this invention applied to a shipping container;

FIG. 6B is a perspective view illustrating a step of removing the packing list from the tri-fold label assembly shown in FIG. 6A; and

FIG. 7 shows several representative tri-fold labels attached via the backing upon which the representative tri-fold labels are affixed or mounted.

### DETAILED DESCRIPTION OF THE PREFERRED EMBODIMENT

For simplicity and clarification, the design factors and layout of the tri-fold label with separable packing list and adhesive backing enclosure according to this invention are explained with reference to an exemplary embodiment of a tri-fold label with separable packing list and adhesive backing enclosure according to this invention. The basic explanation of the tri-fold label with separable packing list and adhesive backing enclosure is applicable for the understanding and design of the constituent components employed in the tri-fold label with separable packing list and adhesive backing enclosure of this invention.

Furthermore, for simplicity and clarification, the embodiments of this invention will be described with reference to a shipping label and a packing list. However, it should be appreciated that the terms “shipping label” and “packing list” are for a basic explanation and understanding of certain of the constituent components of the tri-fold label of this invention. Therefore, the terms “shipping label” and “packing list” are not to be construed as limiting this invention, but should be understood to allow additional or alternative information or indicia, such as, for example, instructions for using or removing the tri-fold label, invoice information, return address information, exchange information, warranty information, or the like, to be included with or substituted for any shipping label and/or packing list information imprinted on the shipping label or packing list portions of the tri-fold label.

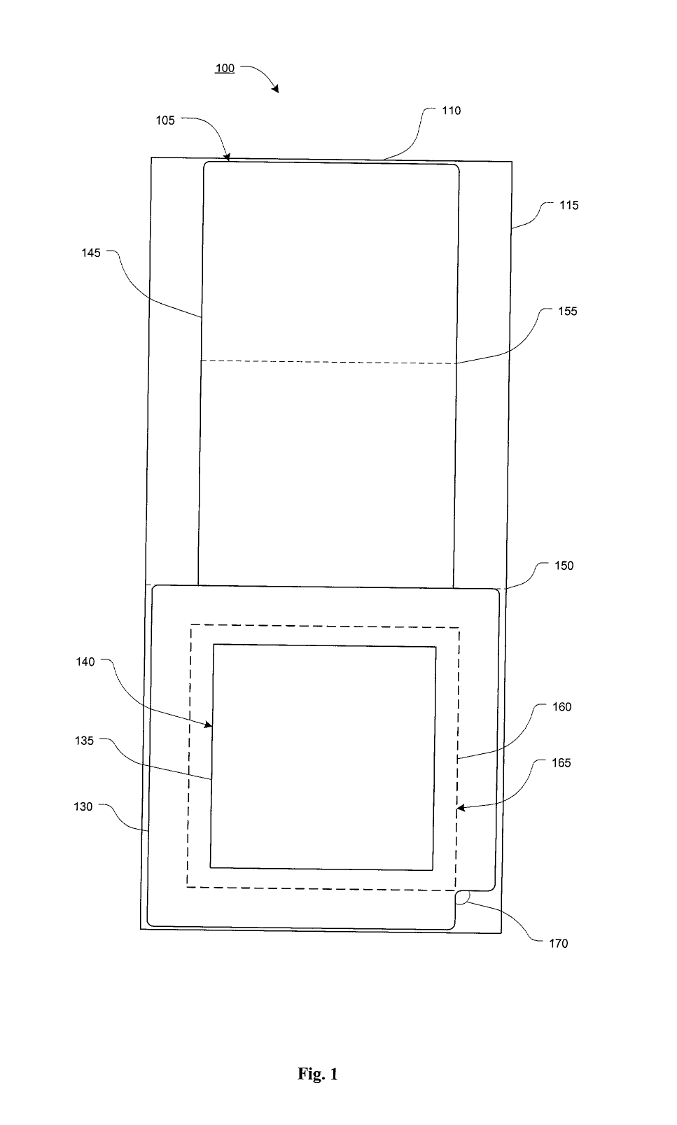

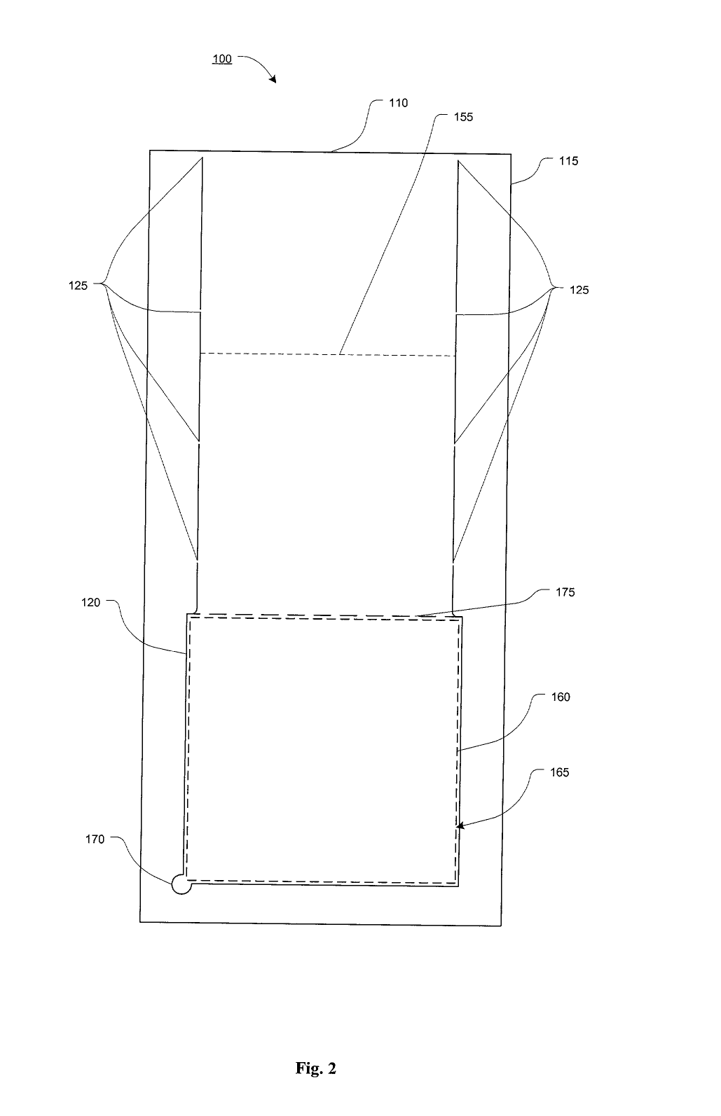

FIGS. 1 and 2 show a first side and a second side view, respectively, of a tri-fold label with separable packing list and adhesive backing enclosure 100 according to this invention. As shown in FIGS. 1 and 2, the tri-fold label 100 comprises a face stock 105 and a removable backing 110. The face stock 105 and the removable backing 110 each have a first side and a second side. At least a portion of the first side of the face stock 105 has an exposed, printable, generally planar surface. It should be appreciated that appropriate materials for the face stock 105 and the removable backing 110 are selected based on the conditions that are expected to occur during use of the tri-fold label 100.

The face stock 105 has an overall T-shaped configuration and is divided into a packing list enclosure 130, a shipping label 140, a packing list 145, and a packing list cover 165. The packing list enclosure 130 and the packing list 145 are separated by a perforation line 150 that extends through the face stock 105, along a common edge along one side thereof. Preferably, the perforation line 150 does not extend into the removable backing 110.

At least a portion of the second side of the face stock 105 is coated with an adhesive layer. In various exemplary embodiments, the adhesive may be a removable, repositionable, or permanent adhesive that can be hot-melt, emulsion, or solvent-based. It should be understood that varying types of adhesives may be used on different portions of the second side of the face stock 105. Depending on the desired application and the conditions that are expected to occur during use of the tri-fold label 100, the particular adhesive that is used on each portion of the second side of the face stock 105 is a design choice and will be obvious and predicable to those skilled in the art.

In various exemplary embodiments, the removable backing 110 is, for example, a carrier strip having a non-stick release coating, such as a silicon layer, applied to the first side thereof. The first side of the removable backing 110 contacts and covers the adhesive layer coated on the second side of the face stock 105. It should be understood that if, for example, a pressure sensitive adhesive is used on a portion of the second side of the face stock 105, the removable backing 110 will removably cover that portion of the second side of the face stock 105. Likewise, if, for example, a permanent adhesive is used on a portion of the second side of the face stock 105, the removable backing 110 will permanently cover that portion of the second side of the face stock 105.

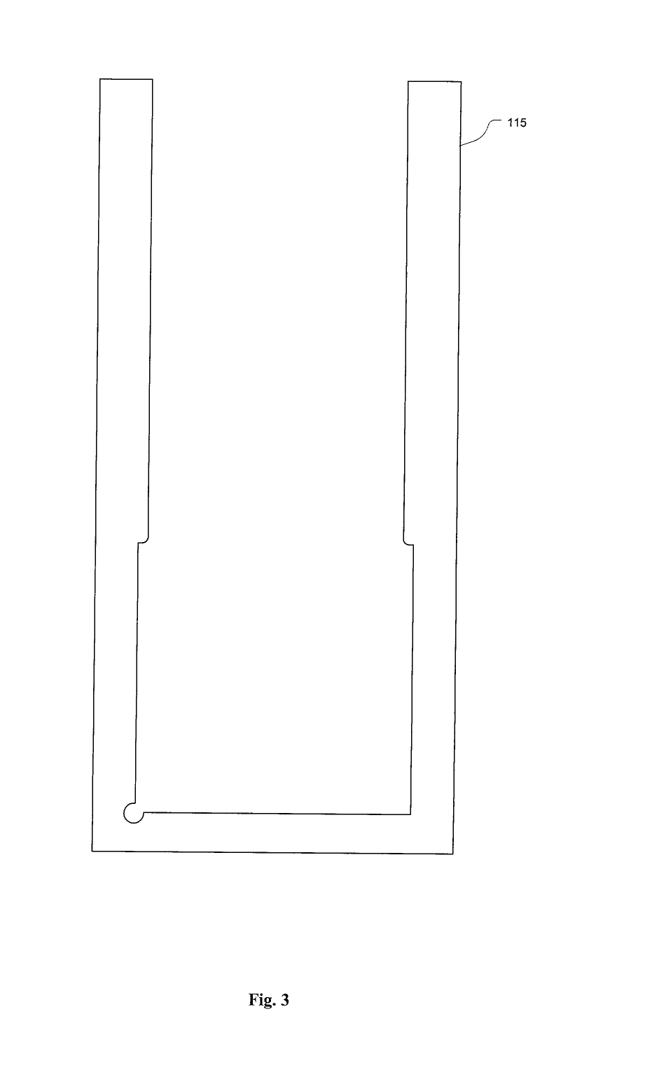

The removable backing 110 includes an outer removable backing 115 that is formed by a removable backing cut line 120. The removable backing cut line 120 extends through the removable backing 110 but does not extend into the face stock 105. Thus, the outer removable backing 115 can be separated from the removable backing 110 of the tri-fold label 100, as shown in FIG. 3.

As further shown in FIG. 3, the outer removable backing 115 comprises a generally U-shaped portion that is formed around and separable from three sides of the removable backing 110. In various exemplary embodiments, the outer removable backing 115 is removably attached to the removable backing 110 by at least one tie 125, as shown in FIG. 2. The at least one tie 125 allows the outer removable backing 115 to remain removably attached to the removable backing 110 until the outer removable backing 115 is to be removed from the removable backing 110.

Returning to FIGS. 1 and 2, the removable backing 110 also includes a first fold line 155 and a second fold line 175. In various exemplary embodiments, the first fold line 155 and the second fold line 175 are perforation lines that extend through the removable backing 110 and not through the face stock 105. However, in various exemplary embodiments, the first fold line 155 may extend through the face stock 105. Preferably, the first fold line 155 and the second fold line 175 are created by perforations formed using approximately four teeth per inch. Alternatively, the first fold line 155 and the second fold line 175 may be created by perforations formed using approximately eight to ten teeth per inch.

The first fold line 155 allows the packing list 145 to be folded into two portions and the second fold line 175 allows the packing list 145 to be folded beneath the packing list enclosure 130. When folded in this manner, the packing list 145 is substantially enclosed by an overlaying border area of the packing list enclosure 130. Thus, when the outer removable backing 115 is removed and the tri-fold label 100 is affixed to a supporting surface, the packing list enclosure 130 removably covers the folded packing list 145.

In various exemplary embodiments, at least a portion of an area on the second side of the face stock 105, as defined by the packing list enclosure 130, is coated with a pressure sensitive adhesive layer that allows the packing list enclosure 130 to be removed from the removable backing 110 and adhesively applied to any desired supporting surface.

The shipping label 140 is created from a portion of the face stock 105 that is within the packing list enclosure 130. The shipping label 140 is defined by a shipping label perforation line 135 and is substantially surrounded on all four sides by the packing list enclosure 130. The shipping label perforation line 135 extends through the face stock 105 such that the shipping label 140 can be removed from the removable backing 110. Preferably, the shipping label perforation line 135 does not extend into the removable backing 110, such that, when the shipping label 140 is removed from the removable backing 110, the removable backing 110 remains intact as a part of the packing list enclosure 130.

In various exemplary embodiments, at least a portion of an area on the second side of the face stock 105, as defined by the shipping label 140, is coated with a pressure sensitive adhesive layer that allows the shipping label 140 to be removed from the removable backing 110 and adhesively applied to any desired supporting surface, such as, for example, an exterior surface of a container.

The packing list cover 165 is also created within the packing list enclosure 130 by a packing list enclosure perforation line 160. Preferably, the packing list enclosure perforation line 160 extends through both the face stock 105 and the removable backing 110. Thus, when the packing list enclosure 130 is adhesively applied to, for example, a container, and the packing list cover 165 is removed from the packing list enclosure 130, any portion of the removable backing 110 as well as any portion of the face stock 105 comprising the packing list cover 165 are removed from the packing list enclosure 130.

In various exemplary embodiments, the packing list enclosure perforation line 160 is a relatively strong connection, such as a perforation formed using approximately eight to ten teeth per inch to connect the packing list enclosure 130 to the packing list cover 165. Alternatively, the packing list enclosure perforation line 160 may be a relatively weak connection, such as a perforation formed using approximately four teeth per inch per inch between the packing list enclosure 130 to the packing list cover 165.

In various exemplary embodiments, the packing list cover 165 optionally includes a precut removal tab 170. The precut removal tab 170 can be added to the packing list cover 165 as part of the packing list enclosure perforation line 160. As shown in FIGS. 1 and 2, the precut removal tab 170 may be a circular tab formed in, for example, a removed comer of the packing list enclosure 130. It should be understood that the precut removal tab 170 and/or the removed comer, if included, may take the form of any shape and may be added in any location that provides an aid for separation of the packing list cover 165 from the packing list enclosure 130.

In various exemplary embodiments, at least a portion of an area on the second side of the face stock 105, between the removable backing cut line 120 and the shipping label perforation line 135, is coated with a permanent adhesive such that when the packing list cover 165 is removed from the packing list enclosure 130, a portion of the face stock 105 between the removable backing cut line 120 and the shipping label perforation line 135 will remain permanently adhered to the packing list cover 165.

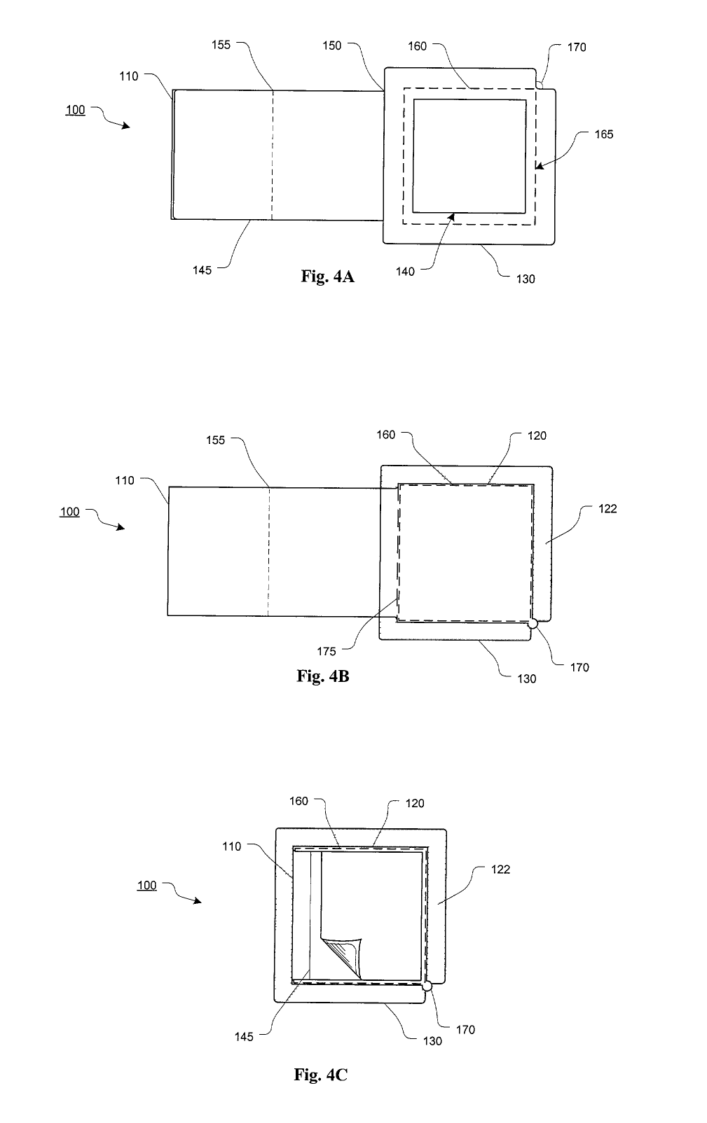

FIG. 4A shows a plan view of the first side of the tri-fold label 100 according to this invention. As shown in FIG. 4A, the outer removable backing 115 has been removed from the tri-fold label 100 and discarded as a waste portion so that the tri-fold label 100 can be affixed to an exterior surface of, for example, a shipping container.

FIGS. 4B and 4C show a plan view of the second side of the tri-fold label 100 of FIG. 4A. As shown in FIGS. 4B and 4C, when the packing list 145 is folded along the first fold line 155 and the second fold line 175, as described above, the packing list 145 is substantially enclosed within the overlaying border area of the packing list enclosure 130.

Furthermore, as illustrated in FIG. 4C, when the packing list 145 is folded beneath the packing list enclosure 130, an adhesive layer 122 is exposed on the second side of the overlaying border area of the packing list enclosure 130.

It should be understood that the adhesive used to form the adhesive layer 122 on the second side of the overlaying border area of the packing list enclosure 130 can be a removable, repositionable, or permanent adhesive and can be hot-melt, emulsion, or solvent-based. Depending on the desired application, the particular adhesive that is used to form the adhesive layer 122 is a design choice and will be obvious and predicable to those skilled in the art.

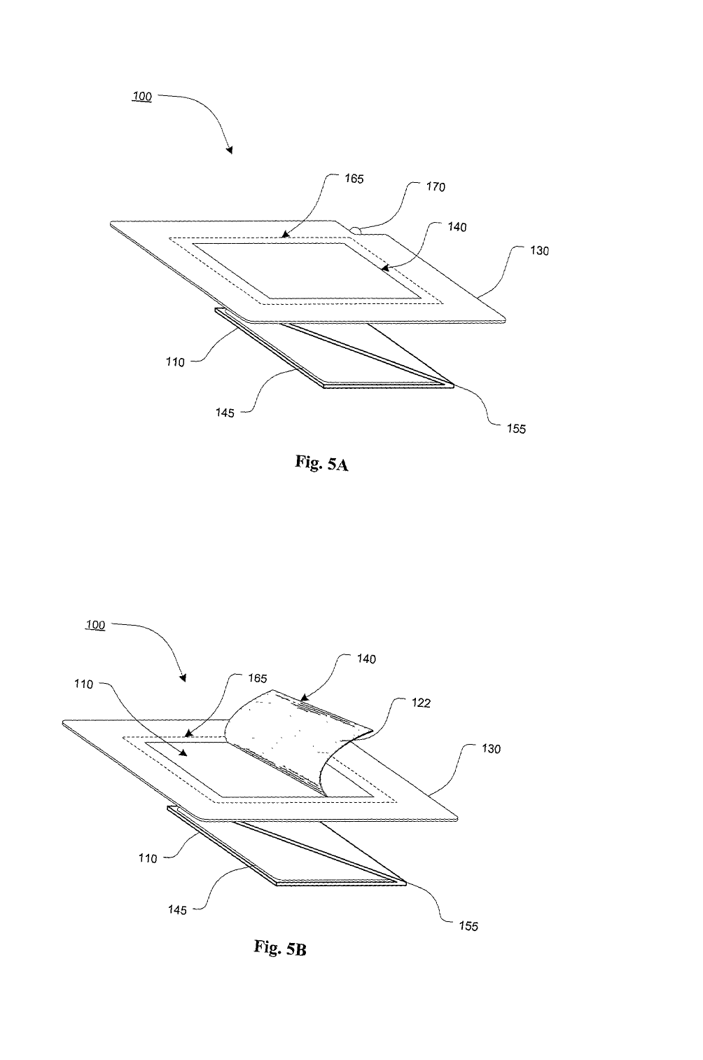

FIGS. 5A and 5B are perspective views of the tri-fold label 100 wherein the outer removable backing 115 has been removed and discarded as a waste portion. FIGS. 5A and 5B illustrate how the tri-fold label 100 can be Z-folded in such a manner as to form a multi-layer laminate with the packing list enclosure 130 completely covering and enclosing the packing list 145.

More specifically, FIG. 5B shows the shipping label 140 being removed from the removable backing 110 and packing list enclosure 130. As also shown in FIG. SB, as the shipping label 140 is removed from the packing list enclosure 130, the removable backing 110 remains intact as a part of the packing list enclosure 130.

Therefore, as illustrated in FIG. 5B, the shipping label 140 can be removed from the packing list enclosure 130 to be placed on an exterior surface of a container, while the packing list enclosure (including the packing list) can be separately applied to, for example, another portion of the exterior surface of the container.

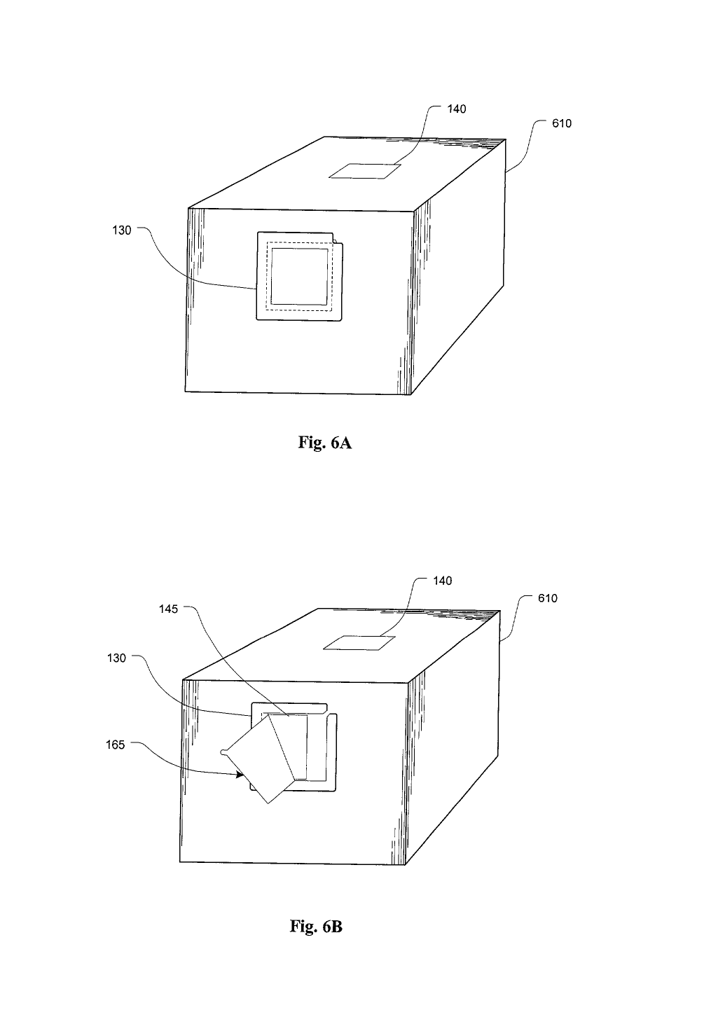

FIG. 6A shows the shipping label 140 removed from the packing list enclosure 130 and affixed on an exterior surface of a container 610. Furthermore, the packing list enclosure 130 is separately affixed to another portion of the exterior surface of a container 610.

FIG. 6B shows the packing list cover 165 being removed from the packing list enclosure 130. As shown in FIG. 6B, as the packing list cover 165 is removed, the packing list 145 is uncovered. When the packing list 145 is uncovered, the perforations forming the second fold line 175 allow the packing list 145 to be separated and removed from the packing list enclosure 130.

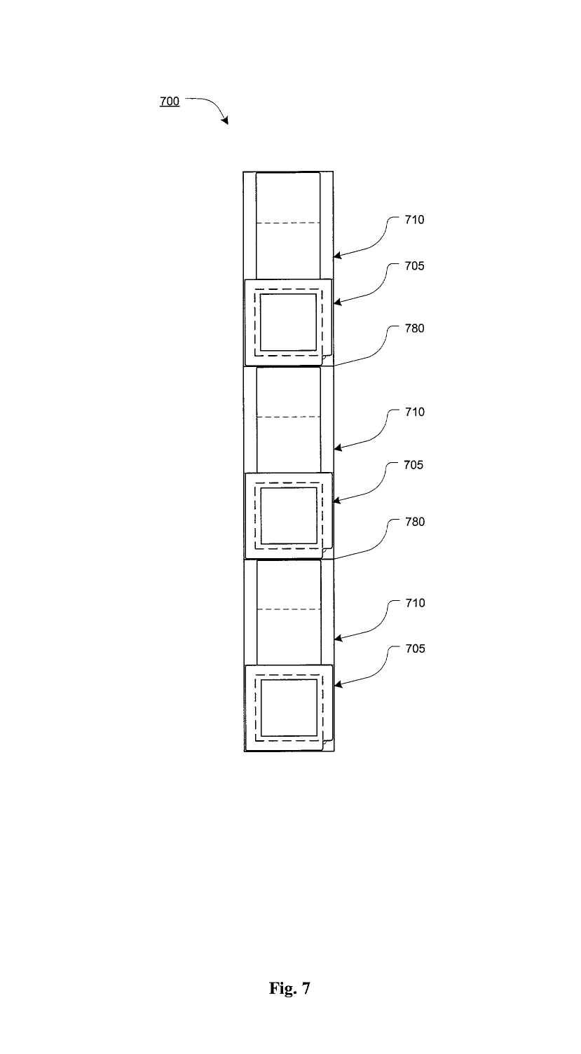

FIG. 7 shows a continuous label stock or web 700. The web 700 comprises several representative tri-fold labels 705 attached via a removable backing 710 upon which the representative tri-fold labels are affixed or mounted. The representative tri-fold labels 705 and the removable backing 710 correspond to the tri-fold label 100 and the removable backing 110, respectively, as described above.

Furthermore, it should be understood that each representative tri-fold label 705 is separably attached to each other representative tri-fold label 705. In various exemplary embodiments, each representative tri-fold label 705 is separably attached to a previous and/or a next representative tri-fold label 705 via a perforation or serration line 780.

It should be appreciated that although the shipping label 140 has been described as being removed from the packing list enclosure 130 and placed on an exterior surface of a container, while the packing list enclosure 130 is separately affixed to another portion of the exterior surface of the container, the shipping label 140 can remain on the packing list enclosure 130. Thus, the shipping label 140 does not have to be separated from the packing list enclosure 130.

It should also be appreciated that although the label described herein has included a packing list 145 that must be folded in order to be of a dimension that can be enclosed beneath the packing list enclosure 130, in various exemplary embodiments, the packing list 145 may be of a dimension that allows the packing list 145 to be enclosed beneath the packing list enclosure 130 without being folded. In such an exemplary embodiment, the first fold line 155 is not necessary.

Likewise, it should also be appreciated that the packing list 145 may be of a dimension that requires that the packing list 145 be folded several times before the packing list 145 is of a dimension that allows the packing list 145 to be enclosed beneath the packing list enclosure 130. In such an exemplary embodiment, multiple fold lines, similar to the first fold line 155 may be necessary.

While this invention has been described in conjunction with the exemplary embodiments outlined above, it is evident that many alternatives, modifications, and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A tri-fold label assembly comprising:
a first label being adhesively connected to a backing material by a pressure-sensitive adhesive on at least a portion of a back surface thereof, wherein the adhesive allows the first label to be removed from the backing material and adhesively applied to a supporting surface;
a label enclosure substantially surrounding the first label being adhesively connected to a backing material by a pressure-sensitive adhesive on at least a portion of a border area of a back surface thereof, wherein the adhesive allows the label enclosure to be removed from the backing material and the label enclosure to be adhesively applied to a supporting surface, wherein the label enclosure includes a separable portion of the label enclosure located between the border area and the first label, being at least partially secured to the label enclosure by a perforation through the label enclosure and the backing material; and
a second label adjacent to the label enclosure being separable from the label enclosure by a line of perforation and adhesively connected to the backing material by a pressure-sensitive adhesive on at least a portion of a back surface thereof;
whereby, the second label is foldable along a first fold line and a second fold line such that the label enclosure completely overlies the folded second label and substantially surrounds the folded second label within the border area.

2. The tri-fold label assembly of claim 1, wherein the pressure-sensitive adhesive is a removable, repositionable, or permanent adhesive.

3. The tri-fold label assembly of claim 1, wherein the pressure-sensitive adhesive is a hot-melt, emulsion, or solvent-based adhesive.

4. The tri-fold label assembly of claim 1, wherein said first label has a layer of adhesive extending over the entire back surface thereof.

5. The tri-fold label assembly of claim 1, wherein said second label has a layer of adhesive extending over the entire back surface thereof.

6. The tri-fold label assembly of claim 1, wherein the label enclosure has a layer of adhesive extending over the entire back surface thereof the border area thereof.

7. The tri-fold label assembly of claim 1, wherein the separable portion of the label enclosure located between the border area and the first label is at least partially secured to the label enclosure on at least three sides by a perforation through the label enclosure and the backing material.

8. The tri-fold label assembly of claim 1, wherein the first label includes printed information on a front surface thereof.

9. The tri-fold label assembly of claim 1, wherein the second label includes printed information on a front surface thereof.

10. The tri-fold label assembly of claim 1, wherein the backing material is in the form of a continuous web upon which individual tri-fold label assemblies are affixed or mounted.

11. The tri-fold label assembly of claim 10, wherein each tri-fold label assembly is separably attached to a previous and/or a next tri-fold label assembly via a perforation or serration through the backing material.

12. A tri-fold label with a separable packing list and adhesive backing enclosure comprising:
a face stock layer having a first side and a second side, wherein at least a portion of the first side has a printable, generally planar surface and wherein the face stock layer is divided into at least some of a first printable portion, a second printable portion, and an enclosure portion,
wherein the second printable portion and the enclosure portion are separated from one another by a common edge along one side thereof, the second printable portion having a smaller dimension along the common edge than the enclosure portion such that when the second printable portion is folded along a first fold line and a second fold line, the enclosure portion completely overlies the folded second printable portion forming a border area substantially surrounding all four sides of the folded second printable portion, the enclosure portion further having an enclosure perforation substantially surrounding at least three sides of the folded second printable portion within the border area, the enclosure portion further having the first printable portion located within the enclosure portion such that the first printable portion is separately removable from the enclosure portion;
an adhesive layer at least partially covering the second side of the face stock layer, wherein the adhesive layer allows the first printable portion of the enclosure portion to be adhesively applied to a supporting surface and allows the border area of the face stock layer to be adhesively applied to a supporting surface; and
a backing layer defined by a continuous strip of carrier material, having a first side and a second side, and removably covering the adhesive layer at least partially covering the second side of the face stock layer, wherein the backing layer includes at least one separable, outer portion of the backing layer that covers the border area of the face stock layer and is independently removable from the backing layer and the adhesive layer, the outer portion of the backing layer defining a waste portion of the backing layer after removal from the backing layer and the adhesive layer.

13. The tri-fold label of claim 12, wherein the first printable portion is suitable for imprinting a shipping address and a second printable portion is suitable for imprinting packing information.

14. The tri-fold label of claim 12, wherein the enclosure portion includes a perforation extending through the face stock layer defining the first printable portion.

15. The tri-fold label of claim 12, wherein the enclosure perforation is a perforation extending through the face stock layer and the backing layer defining a portion of the enclosure portion that is separable from the enclosure portion.

16. The tri-fold label of claim 12, wherein the backing layer includes a perforation extending through the backing layer defining the outer portion of the backing layer.

17. The tri-fold label of claim 12, wherein the backing layer is in the form of a continuous web upon which tri-fold labels are affixed or mounted.

18. The tri-fold label of claim 17, wherein each tri-fold label is separably attached to a previous and/or a next tri-fold label via a perforation or serration through the backing layer.

19. A tri-fold label assembly comprising in combination:
an article; and
a label adhesively secured to an exterior surface of the article, the label having a first label being adhesively connected to a backing material by a pressure-sensitive adhesive on at least a portion of a back surface thereof, wherein the adhesive allows the first label to be removed from the backing material and adhesively applied to a supporting surface;
a label enclosure substantially surrounding the first label being adhesively connected to a backing material by a pressure-sensitive adhesive on at least a portion of a border area of a back surface thereof, the label enclosure being adhesively secured to an exterior surface of the article, wherein the label enclosure includes a separable portion of the label enclosure such that the separable portion of the label enclosure can be separated from the label enclosure exposing the second label; and
a second label being folded along a first fold line and a second fold line such that the label enclosure completely overlies the folded second label and substantially surrounds the folded second label within the border area as the border area is adhesively secured to an exterior surface of the article.

20. The tri-fold label assembly of claim 19, wherein the first label is removed from the backing material and is adhesively secured to an exterior surface of the article at a location different from the location where the label enclosure is adhesively secured to the exterior surface of the article.

21. The tri-fold label assembly of claim 19, wherein the pressure-sensitive adhesive is a removable, repositionable, or permanent adhesive.

22. The tri-fold label assembly of claim 19, wherein the pressure-sensitive adhesive is a hot-melt, emulsion, or solvent-based adhesive.
